(19) United States
(12) Patent Application Publication
(10) Pub. No.: US 2013/0043969 A1
(43) Pub. Date: Feb. 21, 2013

(54) CHOKE COIL

(71) Applicants: Masaru OTA, Tokyo (JP); Yuko KANAZAWA, Tokyo (JP)

(72) Inventors: Masaru OTA, Tokyo (JP); Yuko KANAZAWA, Tokyo (JP)

(21) Appl. No.: 13/495,333

(22) Filed: Jun. 13, 2012

(30) Foreign Application Priority Data
Aug. 18, 2011 (JP) 2011-178861

(51) Int. Cl. H01F 27/28

(52) U.S. Cl. 336/229

(57) ABSTRACT

The present invention provides a choke coil capable of applying an optimum magnetic bias without causing degradation of magnetic characteristics and any adverse effect on a neighboring device which would be caused by a temperature rise, therefore capable of adequately accommodating higher current. A choke coil according to the present invention includes a toroid coil 6 and a core 1 in which a first core 5 inserted in the center of the coil and a second core 3, 4 disposed at an outer periphery of the coil form a closed magnetic circuit. A gap G is formed in the first core 5. A magnet array applying a magnetic bias is placed in the gap G. The magnet array is formed by a plurality of submagnets 7 separated in a plane perpendicular to a direction in which a magnetic flux from the first core 5 interlinks.

### BACKGROUND OF THE INVENTION

1. Field of the Invention

The present invention relates to a choke coil in which a magnet for applying a magnetic bias is placed in a gap in a core that forms a closed magnetic circuit.

2. Description of the Related Art

The capability of maintaining stable characteristics for higher current than ever before is being required of choke coils incorporated in power supply circuits of audio-video equipment, office automation equipment and factory automation equipment because of reduction of voltage for saving power consumption or the increase in power consumption resulting from increased multifunctionality.

To meet the demand, a choke coil has been developed in which a magnet that applies magnetic fluxes that are opposite in direction to magnetic fluxes of a core is placed in a gap in the core to improve direct-current superposition characteristics of the choke coil.

Conventional choke coils in which a magnet of this type is provided in general have a structure in which one magnet having an area required for applying a desired magnetic bias is placed in a gap in the core. The magnet is a disc magnet 50 as illustrated in FIG. 9A or a rectangular magnet 51 as illustrated in FIG. 9B.

However, when the magnetic field from the core of the conventional choke coils described above radically changes, eddy currents are created in the magnets 50 and 51 due to electromagnetic induction, which then cause Joule heat to heat the magnets 50 and 51, increasing the temperature of the choke coil. Consequently, desired magnetic characteristics cannot be achieved or the heat can adversely affect a neighboring device.

The present invention has been made in light of the circumstances described above and an object of the present invention is to provide a choke coil capable of applying an optimum magnetic bias without causing degradation of magnetic characteristics and any adverse effect on a neighboring device which would be caused by a temperature rise, therefore capable of adequately accommodating higher current.

### SUMMARY OF THE INVENTION

To solve the problem, the invention in a first aspect of the invention provides a choke coil including a choke coil including a toroid coil and a core in which a first core inserted in the center of the coil and a second core disposed at an outer periphery of the coil form a closed magnetic circuit. A gap is formed in the first core. A magnet array applying a magnetic bias is placed in the gap. The magnet array is formed by a plurality of submagnets separated in a plane perpendicular to a direction in which a magnetic flux from the first core interlinks.

Modes of the coil include a coil constructed by wire wrapped around a bobbin, a single-wire coil, an edgewise coil, and coils of various other types.

The core may be formed by first cores inserted in the center of the coil and second cores disposed at the outer periphery of the coil into the shape of one rectangle or the shape of two stacked rectangles as a whole.

The invention in a second aspect of the invention provides a choke coil of the first aspect of the invention, wherein a tabular member made of resin or ferrite is provided in the gap, the tabular member has a plurality of holes passing from a top surface to a bottom surface of the tabular member, and the submagnets are inserted in the holes.

The invention in a third aspect of the invention is a choke coil according to the first or second aspect of the invention, wherein a plurality of recesses are formed in a surface of the first core, the surface facing the gap in the first core, and ends of the submagnets are inserted in the recesses.

The invention in a fourth aspect of the invention provides a choke coil according to any one of the first to third aspects of the invention, wherein the plurality of submagnets are located off the center of a magnetic path of the first core.

### ADVANTAGEOUS EFFECTS OF THE INVENTION

The invention according to any of the first to fourth aspects of the invention reduces or inhibits generation of eddy currents in each of the submagnets even when a magnetic field from the first core has radically changed, as compared with a conventional single magnet because a plurality of submagnets that have areas into which an area required for applying a desired magnetic bias is divided are placed in a gap in the first core. As a result, the total amount of heat produced in the submagnets can be reduced to prevent harmful temperature rise in the choke coil and loss due to the eddy currents can also be reduced.

It is preferable that the plurality of submagnets be placed in such a manner that the magnetic force is evenly distributed. In practice, however, the magnetic attractive force between the submagnets makes it difficult to accurately space the plurality of submagnets in the plane because each of the submagnets has a specific magnetic force.

In that respect, the invention in the second aspect of the invention enables the submagnets to be readily evenly spaced because the resin or ferrite tabular member in which a plurality of holes are made is provided in the gap and the submagnets are inserted in the holes in the tabular member.

In addition, since the tabular member after the submagnets have been inserted in the holes is fitted into the gap in the first core to accomplish the placement of the submagnets, the number of man-hours needed to manufacture the choke coil can be reduced. Moreover, more holes than the number of the submagnets may be made in the tabular member to enable the magnetic bias to be flexibly adjusted later by appropriately changing the locations and/or the number of the submagnets.

Alternatively, placement of the submagnets can be facilitated by forming a plurality of recesses in a surface that faces the gap in the first core and inserting ends of the submagnets into the recesses as in the invention according to the third aspect of the invention.

Furthermore, the invention in the fourth aspect of the invention can reduce magnetic fluxes interlinking with the submagnets to further inhibit generation of eddy currents themselves which produce heat, because the submagnets are not placed in the center of the magnetic path in the first core where magnetic fluxes are more likely to concentrate but instead are located off the center of the magnetic path.

### BRIEF DESCRIPTION OF THE DRAWINGS

FIG. 1A is a plan view of one embodiment of a choke coil according to the present invention;

FIG. 1B is a front elevation view of the choke coil; and FIG. 1C is a longitudinal sectional view of the choke coil;

FIG. 2A is a plan view illustrating the shape of a core of the choke coil; FIG. 2B is a front elevation view of the core;

FIGS. 3A, 3B and 3C are diagrams illustrating a shape of a tabular member and a mode of use of the tabular member;

FIGS. 4A, 4B and 4C are diagrams illustrating another shape of the tabular member of the choke coil and another mode of use of the tabular member;

FIG. 5 is a front elevation view illustrating submagnets positioned with the core of the choke coil;

FIG. 6A is a plan view illustrating a first practical example of the present invention;

FIG. 6B is a plan view illustrating a comparative example;

FIG. 7A is a plan view illustrating a second practical example of the present invention;

FIG. 7B is a plan view illustrating a comparative example;

FIG. 8A is a plan view illustrating a third practical example of the present invention;

FIG. 8B is a plan view illustrating a fourth practical example of the present invention as a comparative example; and

FIGS. 9A and 9B are plan views illustrating shapes of a magnet used in a conventional choke coil.

### DETAILED DESCRIPTION OF THE PREFERRED EMBODIMENTS

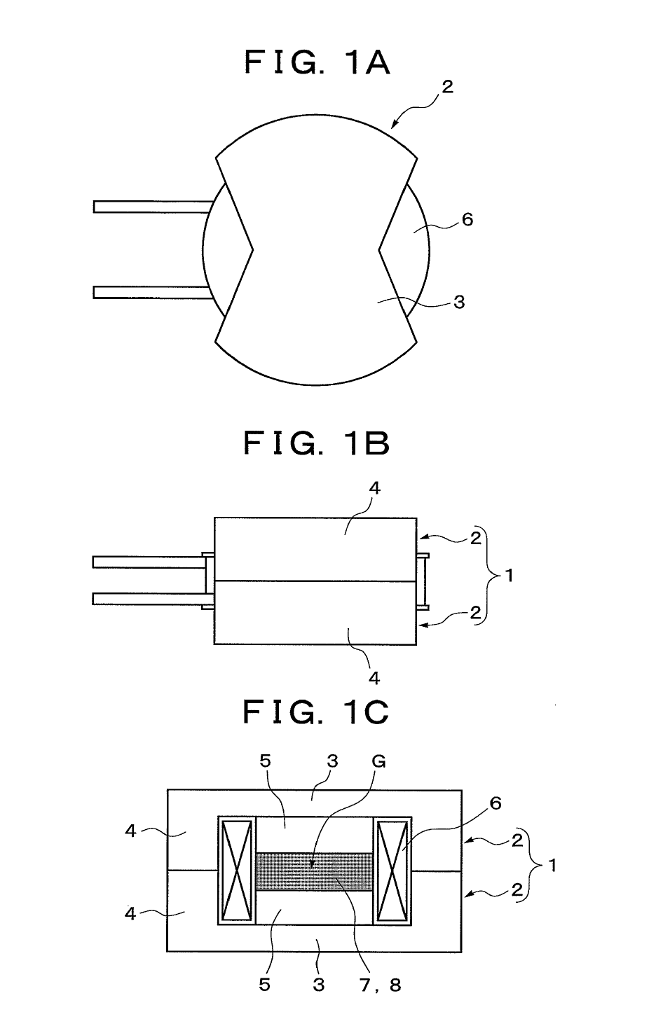

FIGS. 1 to 5 illustrate an embodiment of a choke coil according to the present invention and a variation thereof. Reference numeral 1 in the drawings denotes a ferrite core.

The ferrite core 1 is formed by a pair of butterfly cores 2, 2, each of which has the shape of a letter E viewed from the front, into the shape of two stacked rectangles as a whole as viewed from the front.

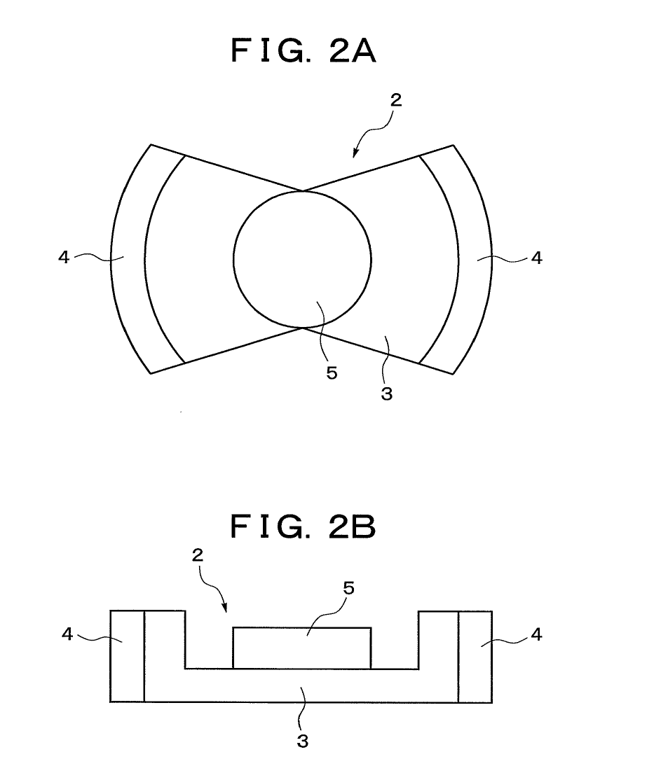

As illustrated in FIGS. 2A and 2C, each of the butterfly cores 2 includes a tabular portion 3, substantially plate-like outer legs 4 provided vertically at both ends of the length of the tabular portion 3, and a cylindrical center leg 5 vertically provided in the center between the outer legs 4, all of which are formed into a unitary structure. The center leg 5 is shorter in height than the outer legs 4. The tabular portion 3 is formed in the shape of a pair of sectors (fan shapes) having a width that gradually increases from the center leg 5 toward the outer legs 4 at both sides. The outer and inner peripheral surfaces of the outer legs 4 at the both ends are formed in the shape of arc surfaces centered on the axis line of the center leg 5.

The end surfaces of the outer legs 4 are joined together with a coil 6 having a substantially cylindrical appearance between them while the tabular portions 3 are located at the edges of the coil 6 and the center legs 5 are inserted in the coil, so that the pair of butterfly cores 2 are formed into a unitary structure. As a result, the center legs 5 (a first core) inserted in the center of the coil 6 of the pair of butterfly cores 2 and the outer legs 4 and the tabular portions 3 (a second core) that surround the outer periphery of the coil 6 form the ferrite core 1 having substantially the shape of two stacked rectangles, which forms a closed magnetic circuit, and a gap G is formed between both center legs 5.

A tabular member 8 in which a plurality of submagnets 7 are inserted is interposed in the gap G.

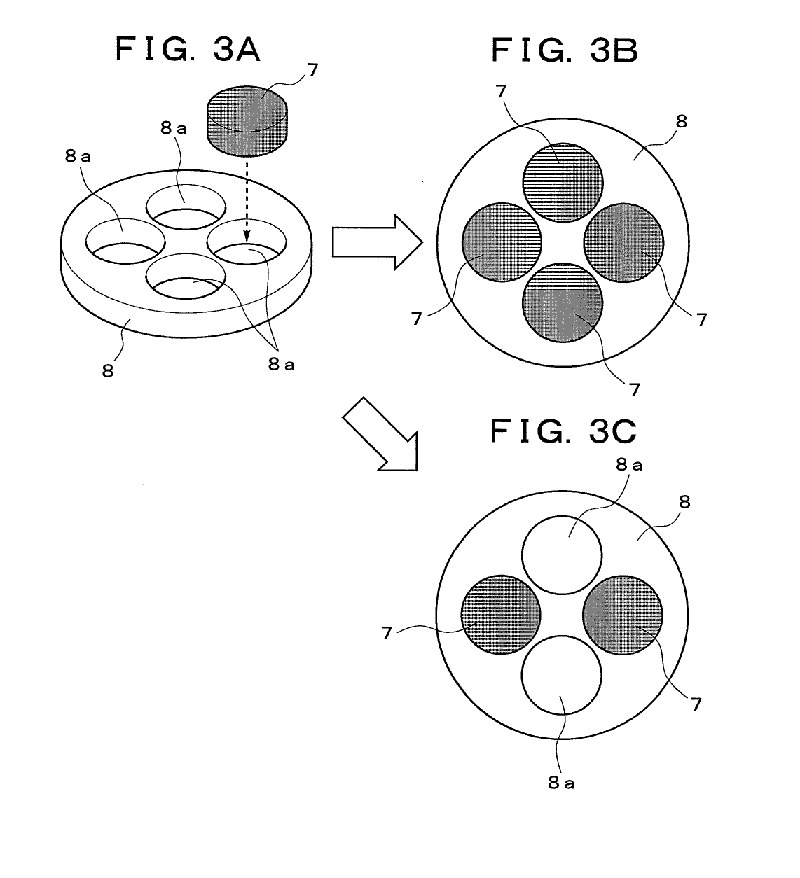

The tabular member 8 is made of resin or ferrite into the shape of a disc as illustrated in FIG. 3A. A plurality of (four in the figure) circular holes 8a passing from the upper surface to the bottom surface are bored in positions symmetrically to each other with respect to the center of the tabular member 8. A submagnet 7 is inserted in each of the holes 8a as illustrated in FIG. 3B.

Each of the submagnets 7 is a neodymium magnet or a samarium-cobalt magnet formed into the shape of a disc so that the area of each submagnet 7 is a quarter (quadrisection) of the area needed to apply a desired magnetic bias. The submagnets 7 are spaced apart from each other in a plane perpendicular to the direction in which magnetic fluxes from the center leg 5 of the ferrite core 1 interlink. In this arrangement, the four submagnets 7 are located off the center of the magnetic path of the center leg 5 in the ferrite core 1.

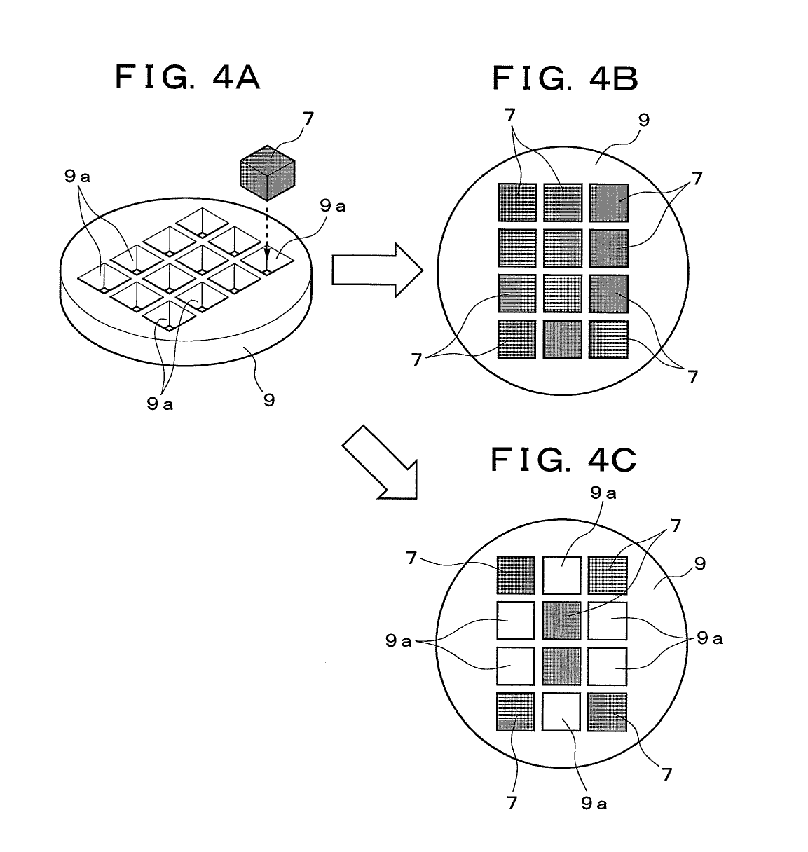

FIG. 4A illustrates a modification of the tabular member. The tabular member 9 is also made of resin or ferrite into the shape of a disc. However, a plurality of square holes 9a (12 holes in a matrix of 3 columns and 4 rows in the figure) passing from the top surface to the bottom surface are bored in the tabular member 9. A square-plate submagnet 7 is inserted into each hole 9a as illustrated in FIG. 4B.

In the choke coil configured as described above, since the submagnets 7 each having a quarter or quadrisection (twelve equal areas in the modification of FIGS. 4A-4C) of the area needed to apply a desired magnetic bias are placed in the gap G formed between the center legs 5 of a pair of butterfly cores 2, generation of eddy currents in each submagnet 7 is reduced or inhibited as compared with a conventional magnet that uses a single magnet, even when a magnetic field from the center legs 5 of the ferrite core 1 has radically changed.

Consequently, the total amount of heat produced in the four submagnets 7 (twelve submagnets 7 in the modification of FIGS. 4A-4C) can be reduced to prevent a harmful temperature rise in the choke coil and loss due to the eddy currents can be minimized. In addition, the ferrite core 1 in which the opposed butterfly cores 2 are placed has excellent core loss characteristics and direct-current superposition characteristics. Therefore, by combining the ferrite core with the submagnets 7 which apply the magnetic bias, a choke coil that is smaller in size, lighter in weight, and more economical than conventional ones can be implemented.

Moreover, since resin or ferrite tabular member 8 or 9 in which four holes 8a or twelve holes 9a are made is provided in the gap G and the submagnets 7 are inserted in the holes 8a, 9a in the tabular member 8, 9, the submagnets 7 can be readily evenly disposed.

Furthermore, since the tabular members 8, 9 after the submagnets 7 have been inserted in the holes 8a, 9a is fitted into the gap G between the center legs 5 to accomplish the placement of the submagnets 7, the number of man-hours needed for manufacturing can be reduced.

In addition, making more holes 8a, 9a in the tabular member 8, 9 than the number of submagnets 7 required as illustrated in FIGS. 3C and 4C enables the magnetic bias to be adjusted by appropriately changing the locations and/or number of the submagnets 7.

Furthermore, since the submagnets 7 are not located in the center of the magnetic path from the center leg 5 where magnetic fluxes are more likely to concentrate but instead are located off the center of the magnetic path as illustrated in FIGS. 3A to 3C, magnetic fluxes that interlink with the submagnets 7 can be reduced to further inhibit generation of eddy currents themselves which would produce heat.

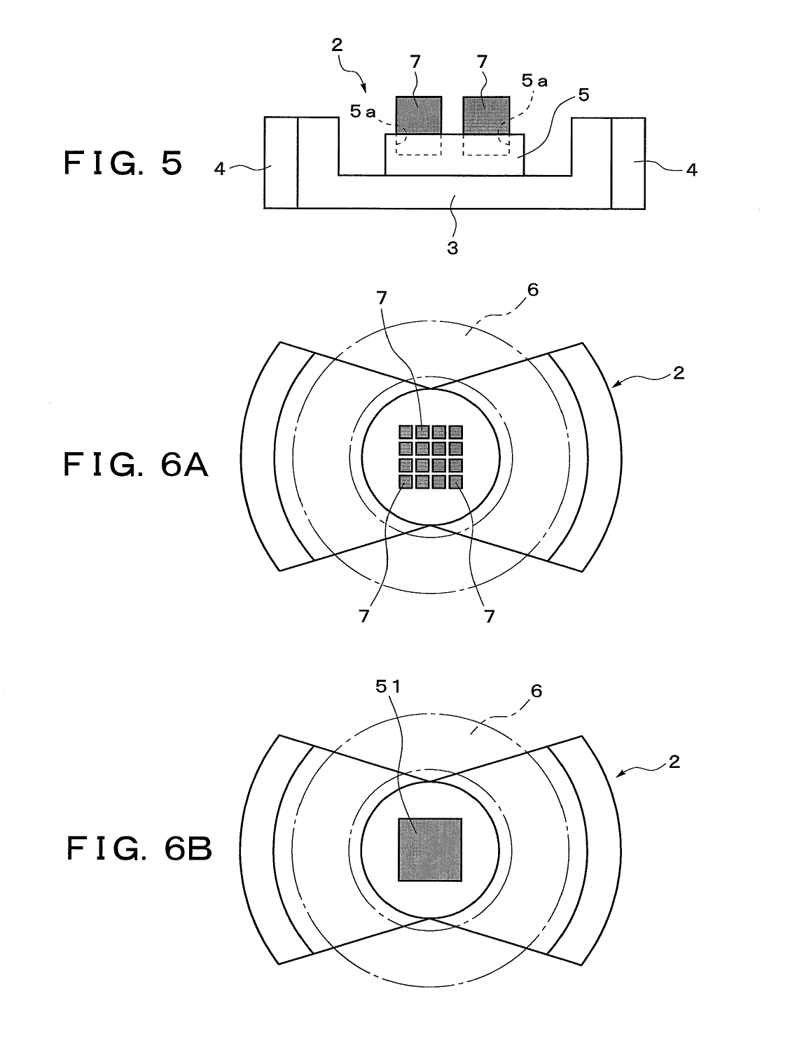

While the tabular member 8, 9 in which a plurality of submagnets 7 are inserted in holes 8a, 9a is placed in the gap G between the center legs 5 in the embodiment described above, the present invention is not limited to this. For example, as illustrated in FIG. 5, a plurality of recesses 5a may be formed in the surface of the center leg 5 that faces the gap G and then one end of each submagnet 7 may be inserted in each recess 5a to position and place the submagnets.

While the tabular member 8, 9 may be made of any of resin and ferrite, the tabular member 8, 9 made of ferrite can further increase heat dissipation by heat conduction, and improve magnetic bias characteristics.

### PRACTICAL EXAMPLES

First, an experiment for comparison of the amounts of heat produced in magnets was conducted on a choke coil of a first practical example with sixteen rectangular-plate submagnets 7 illustrated in FIG. 6A according to the present invention and on a conventional choke coil with a single rectangular-plate magnet 51 illustrated in FIG. 6B.

In this experiment, butterfly cores 2 of the same shape were used as the ferrite cores 1 and the sum of the areas of the submagnets 7 was equal to the area of the magnet 51.

Table 1 shows the results of the experiment on the choke coils illustrated in FIGS. 6A and 6B. The results in Table 1 demonstrate that the amount of heat produced in the submagnets 7 in the first practical example of the invention is approximately 1/14 of that of the conventional magnet 51.

TABLE 1

| | First practical | |
|---|---|---|
| | example | Conventional form |
| | Submagnets | Single magnet |
| Amount of heat | 1.2 [W] | 17 [W] |
| produced in | | |
| magnet(s) | | |

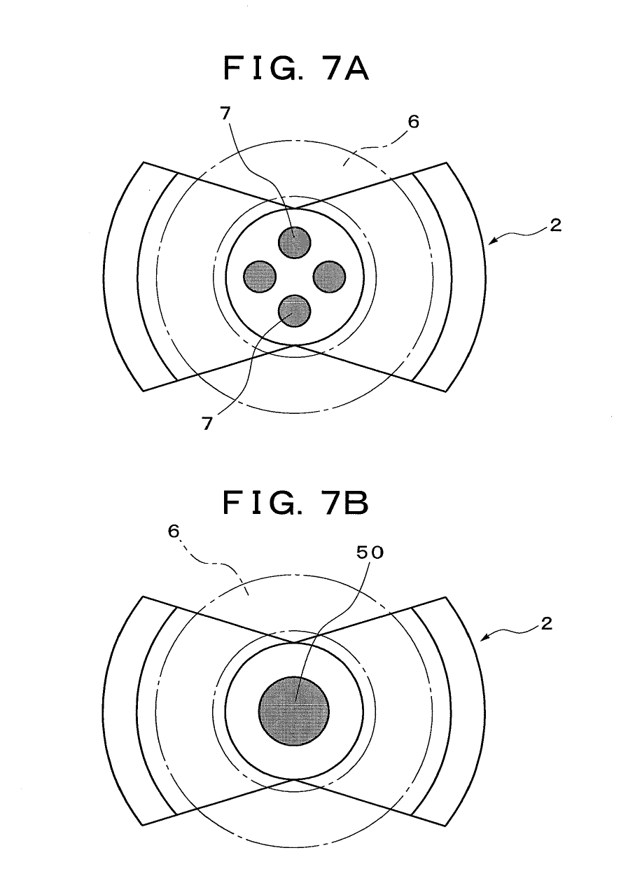

Then, using butterfly cores 2 similar to the ones used in the example, an experiment for comparing the amounts of heat produced in magnets was conducted on a choke coil of a second practical example with four disc-like submagnets 7 illustrated in FIG. 7A according to the present invention and on a conventional choke coil with a single disc-like magnet 50 illustrated in FIG. 7B. Again, the sum of the areas of the submagnets 7 was equal to the area of the magnet 50.

The results of the experiment on the choke coils in FIGS. 7A and 7B demonstrate that the amount of heat produced in the submagnets 7 in the second practical example is approximately ⅓ of that of the conventional magnet 50.

TABLE 2

| | Second practical | |
|---|---|---|
| | example | |
| | Submagnets in | Conventional form |
| | adjusted locations | Single magnet |
| Amount of heat | 3.7 [W] | 12 [W] |
| produced in | | |
| magnet(s) | | |

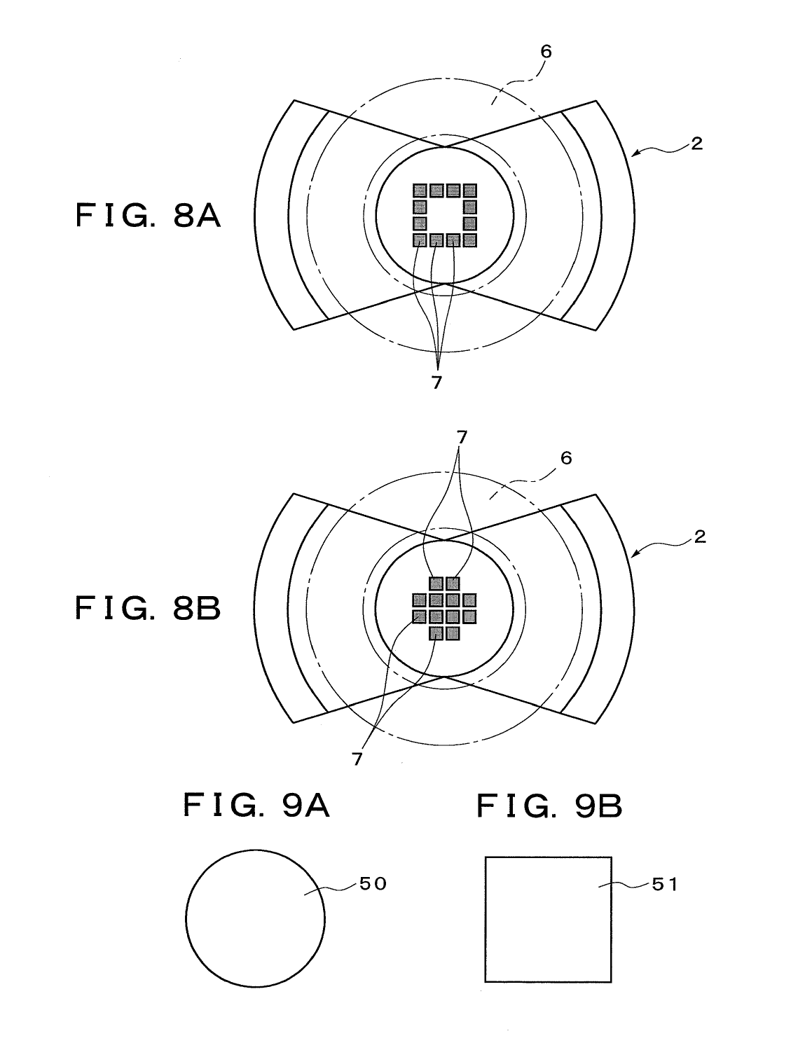

Then, an experiment for comparing the amounts of heat produced in magnets was conducted on a choke coil of a third practical example according to the present invention in which 12 rectangular-plate submagnets 7 illustrated in FIG. 8A were located off the center of the magnetic path from the center leg 5 and on a choke coil of a fourth practical example according to the present invention in which the same number of submagnets of the same shape as those of the third practical example were placed in and around the center of the magnetic path from the center leg 5 as illustrated in FIG. 8B.

The results of the experiment on the choke coils in FIGS. 8A and 8B shown in Table 3 demonstrate that the amounts of heat produced in both of the choke coils are smaller than the amounts of heat in the conventional choke coils and that the amount of heat produced in the choke coil of the third practical example illustrated in FIG. 8A in which the submagnets 7 are located off the center of the magnetic path from the center leg 5 is smaller than that in the choke coil of the fourth practical example.

TABLE 3

| | Third practical | |
|---|---|---|
| | example | Fourth practical |
| | No magnet in | example |
| | center of magnetic | Magnets in center |
| | path | of magnetic path |
| Amount of heat | 2.62 [W] | 2.74 [W] |
| produced in | | |
| magnet(s) | | |

1. A choke coil comprising a toroid coil and a core in which a first core inserted in the center of the coil and a second core disposed at an outer periphery of the coil form a closed magnetic circuit, a gap being formed in the first core, a magnet array applying a magnetic bias being placed in the gap;
wherein the magnet array is formed by a plurality of submagnets separated in a plane perpendicular to a direction in which a magnetic flux from the first core interlinks.

2. The choke coil according to claim 1, wherein a tabular member made of resin or ferrite is provided in the gap, the tabular member having a plurality of holes passing from a top surface to a bottom surface of the tabular member, and the submagnets are inserted in the holes.

3. The choke coil according to claim 1, wherein a plurality of recesses are formed in a surface of the first core, the surface facing the gap in the first core, and ends of the submagnets are inserted in the recesses.

4. The choke coil according to claim 1, wherein the plurality of submagnets are located off the center of a magnetic path of the first core.
